(19) United States
(12) Patent Application Publication
(10) Pub. No.: US 2009/0070957 A1
(43) Pub. Date: Mar. 19, 2009

(54) IMAGE FORMING APPARATUS

(75) Inventor: Tetsuo SHIBA, Yokohama-shi (JP)

Correspondence Address: PATTERSON & SHERIDAN, L.L.P., 3040 POST OAK BOULEVARD, SUITE 1500, HOUSTON, TX, 77056, US

(73) Assignees: KABUSHIKI KAISHA TOSHIBA, Tokyo (JP); TOSHIBA TEC KABUSHIKI KAISHA, Tokyo (JP)

(21) Appl. No.: 12/206,326

(22) Filed: Sep. 8, 2008

Related U.S. Application Data
(60) Provisional application No. 60/972,231, filed on Sep. 13, 2007.

(51) Int. Cl. E05D 7/00

(52) U.S. Cl. 16/223

(57) ABSTRACT

An image forming apparatus includes a first opening and closing member that rotates about a first hinged end, a second opening and closing member provided so as to oppose the first opening and closing member, the second opening and closing member rotating about a second hinged end in association with opening of the first opening and closing member, and an operating portion provided on the first opening and closing member, arranged at a position to avoid interference of an end portion of the second opening and closing member when opening the first opening and closing member and the second opening and closing member, and which rotate the first opening and closing member.

### CROSS-REFERENCE TO RELATED APPLICATION

This application is based upon and claims the benefit of priority from prior Application No. 60/972,231, filed Sep. 13, 2007, the entire contents of which are incorporated herein by reference.

### TECHNICAL FIELD

The present invention relates to an image forming apparatus having a structure in which two opening and closing members each having an independent hinged end are arranged in parallel.

### BACKGROUND

In the related art, two opening and closing members being provided in an image forming apparatus and each having an independent hinged end are arranged in parallel in the opening direction.

The opening and closing member on the upstream side with respect to the opening direction (hereinafter, referred to as “upstream opening and closing member) has a portion having a specific shape (for example a sloped shape) to allow the opening and closing member on the downstream side with respect to the opening direction (hereinafter, referred to as “downstream opening and closing member) to be opened smoothly without scratch even when the upstream opening and closing member is opened in a state in which the downstream opening and closing member is not opened. When an operating portion (grip) provided on the upstream opening and closing member is arranged near the sloped shape provided on the upstream opening and closing member, and a user opens the upstream opening and closing member, the user is at risk of getting his or her hand wedged between the downstream opening and closing member which moves along the sloped shape provided on the upstream opening and closing member and the operating portion.

FIG. 10 and FIG. 11 are cross-sectional views showing an operating portion 702 in the related art provided on a first opening and closing member 70. When the user inserts his or her hand in the operating portion 702 and pulls the first opening and closing member 70 in an opening direction A, a second opening and closing member 80 rotates along a slope surface 703 of the first opening and closing member 70. At this time, a distance X of an opening provided on an end surface 704 of the first opening and closing member 70 is short. Therefore, as shown in FIG. 11, when the user opens the first opening and closing member 70, he or she is at risk of getting his or her hand wedged between the second opening and closing member 80 which moves along the slope surface 703 of the first opening and closing member 70 and the operating portion 702 provided on the first opening and closing member 70.

Accordingly, it is an object of the present invention to provide an image forming apparatus in which a user is not at risk of getting his or her operating hand wedged even when the user opens a plurality of opening and closing members provided in parallel so as to be rotated in the same opening direction.

### SUMMARY

According to one aspect of the present invention, there is provided an image forming apparatus comprising: a first opening and closing member that rotates about a first hinged end; a second opening and closing member provided so as to oppose the first opening and closing member, the second opening and closing member rotating about a second hinged end in association with opening of the first opening and closing member; and an operating portion provided on the first opening and closing member, arranged at a position to avoid interference of an end portion of the second opening and closing member when opening the first opening and closing member and the second opening and closing member, and which rotate the first opening and closing member.

### DESCRIPTION OF THE DRAWINGS

FIG. 1 is a schematic drawing showing an appearance of an image forming apparatus according to an embodiment;

FIG. 2 is a cross-sectional view showing a first opening and closing member and a second opening and closing member according to the embodiment;

FIG. 3 is a cross-sectional view showing the first opening and closing member and the second opening and closing member according to the embodiment;

FIG. 4 is a cross-sectional view showing the first opening and closing member and the second opening and closing member according to the embodiment;

FIG. 5 is an upper perspective view showing the first opening and closing member and the second opening and closing member according to the embodiment;

FIG. 6 is a cross-sectional view showing an operating portion according to the embodiment;

FIG. 7 is a cross-sectional view showing the operating portion according to the embodiment;

FIG. 8 is a cross-sectional view showing the first opening and closing member and the second opening and closing member according to the embodiment;

FIG. 9 is a cross-sectional view showing the first opening and closing member and the second opening and closing member according to the embodiment;

FIG. 10 is a cross-sectional view showing a first opening and closing member and a second opening and closing member in the related art;

FIG. 11 is a cross-sectional view showing the first opening and closing member and the second opening and closing member in the related art;

FIG. 12 is a cross-sectional view showing the first opening and closing member and the second opening and closing member according to a second embodiment; and

FIG. 13 is a cross-sectional view showing the first opening and closing member and the second opening and closing member according to a third embodiment.

### DETAILED DESCRIPTION

Embodiments will be described below.

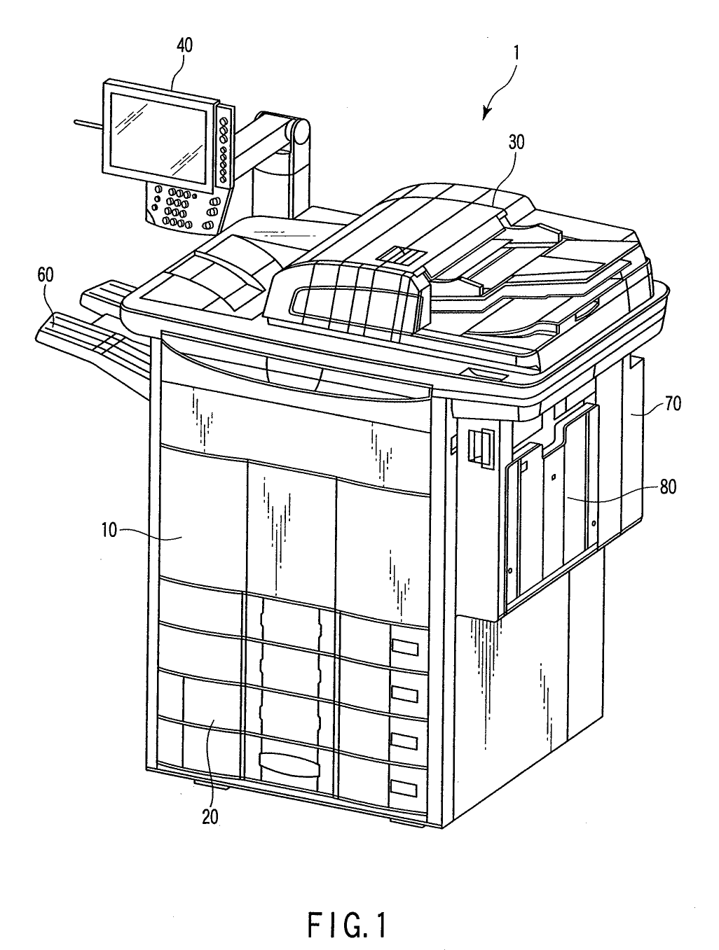

FIG. 1 is a perspective view showing an appearance of an image forming apparatus 1 according to an embodiment. The image forming apparatus 1 includes an image forming unit 10 that outputs image information as an output image which is referred to as a hard copy or a print out, a paper feeding unit 20 which is able to supply paper (output medium) of a given size used for output the image to the image forming unit 10, and a scanner that scans the image information as an object of image formation in the image forming unit 10 from an object (hereinafter referred to as an original document) having the image information as image data. The image forming apparatus 1 includes an automatic document feeder 30 above the image forming unit 10. When the original document is a sheet, the automatic document feeder 30 discharges a scanned original document from a scanning position to a discharging position after the scanning of the image information by the scanner is finished, and guides a subsequent original document to the scanning position. The image forming apparatus 1 also includes an instruction entering unit, that is, a control panel 40 that gives instructions to the image forming unit 10 to start image formation or to the scanner to start scanning of the image information on the original document.

The image forming apparatus 1 includes a paper discharge tray 60 for discharging paper printed by the image forming unit 10 on a side surface thereof. The image forming apparatus 1 includes the first opening and closing member 70 and the second opening and closing member 80 on a side surface opposite from the side on which the paper discharge tray 60 is provided.

The first opening and closing member 70 is a paper carrying unit connected to the image forming unit 10. The second opening and closing member 80 is a manual paper feeding unit provided in contact with the first opening and closing member 70. The first opening and closing member 70 and the second opening and closing member 80 are able to open and close independently about different axes of rotation. The first opening and closing member 70 and the second opening and closing member 80 are each formed into a substantially parallelepiped box shape.

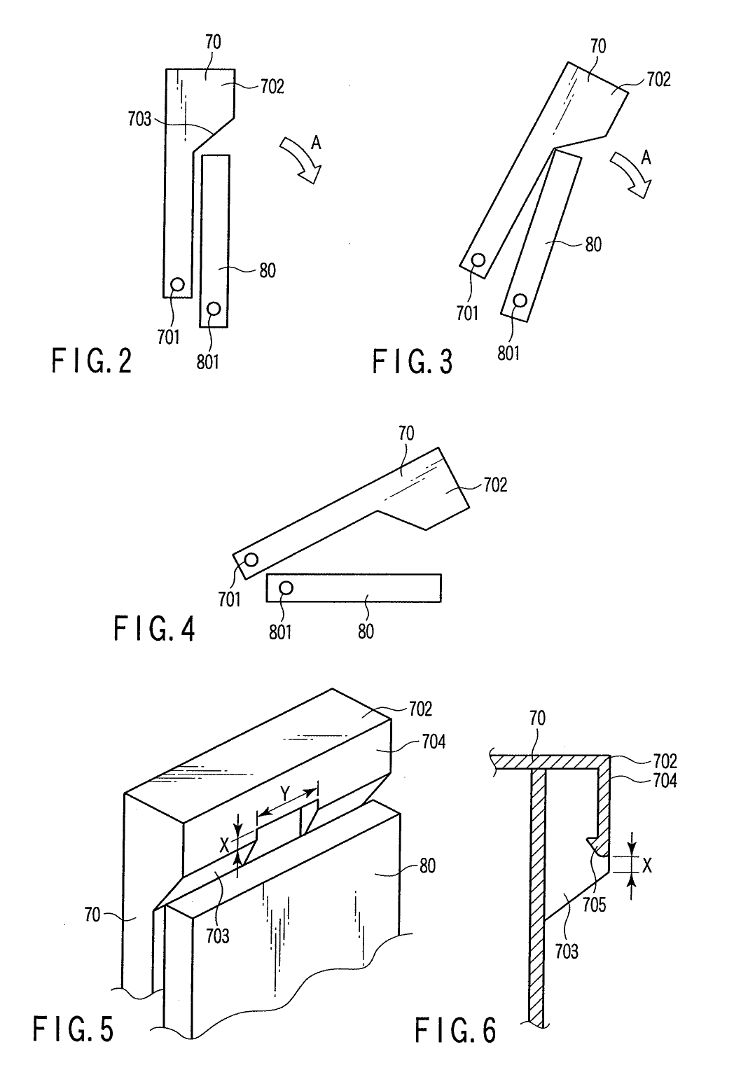

FIG. 2 is a cross-sectional view of the first opening and closing member 70 and the second opening and closing member 80. A state in which the first opening and closing member 70 is in contact with the image forming apparatus 1, that is, a state in which the first opening and closing member 70 is positioned along the height direction is defined as a closed state. A state in which the first opening and closing member 70 is not in contact with the image forming apparatus 1, that is, a state in which the first opening and closing member 70 is positioned along the horizontal direction is defined as an opened state. Likewise, a state in which the second opening and closing member 80 is in contact with the first opening and closing member 70, that is, a state in which the second opening and closing member 80 is positioned along the height direction is defined as the closed state. Likewise, a state in which the second opening and closing member 80 is not in contact with the first opening and closing member 70, that is, a state in which the second opening and closing member 80 is positioned along the horizontal direction is defined as the opened state.

When the first opening and closing member 70 is in the closed state with respect to the image forming apparatus 1, the first opening and closing member 70 opposes the side surface of the image forming apparatus 1. The first opening and closing member 70 has a hinged end 701 extending along the horizontal direction of the image forming apparatus 1 at one end thereof.

When the first opening and closing member 70 is in the closed state with respect to the image forming apparatus 1, the other end of the first opening and closing member 70 extends from the hinged end 701 in the height direction with respect to the height direction of the image forming apparatus 1. A portion of the first opening and closing member 70 on the other end side rotates along the opening direction A about the hinged end 701.

When the second opening and closing member 80 is in the closed state with respect to the image forming apparatus 1, the second opening and closing member 80 opposes an outer surface of the first opening and closing member 70. In other words, the first opening and closing member 70 and the second opening and closing member 80 are provided in this order from the side surface of the image forming apparatus 1 with respect to the horizontal direction. The second opening and closing member 80 includes a hinged end 801 extending along the horizontal direction of the image forming apparatus 1 at one end of the second opening and closing member 80. When the second opening and closing member 80 is in the closed state, the other end of the second opening and closing member 80 extends from the hinged end 801 in the height direction with respect to the height direction of the image forming apparatus 1. A portion of the second opening and closing member 80 on the other end side rotates along the opening direction A about the hinged end 801. When the first opening and closing member 70 and the second opening and closing member 80 are in the closed state with respect to the image forming apparatus 1, opposed surfaces thereof may be in contact with each other or apart from each other by a predetermined distance.

The second opening and closing member 80 has a shape of getting into the interior of the first opening and closing member 70 when the first opening and closing member 70 and the second opening and closing member 80 are in the closed state with respect to the image forming apparatus 1. In other words, the first opening and closing member 70 has an L-shape in cross-section obtained by depressing a part of the parallelepiped box shape. The second opening and closing member 80 has the parallelepiped box shape of an I-shape in cross-section. The first opening and closing member 70 includes an operating portion 702 on the other end side, which is opposite from the one end side where the hinged end 701 is provided for opening and closing the first opening and closing member 70 with respect to the image forming apparatus 1.

The second opening and closing member 80 has a shape to get in and fit the depression formed by the operating portion 702 of the first opening and closing member 70. The operating portion 702 of the first opening and closing member 70 has a slope surface 703 inclining upward from the bottom with respect to the height direction of the image forming apparatus 1. The slope surface 703 is a surface which the second opening and closing member 80 comes into contact with.

FIG. 3 is a cross-sectional view of the first opening and closing member 70 and the second opening and closing member 80 in a course of moving from the closed state to the opened state with respect to the image forming apparatus 1. When the first opening and closing member 70 rotates in the opening direction A from the closed state to the opened state with respect to the image forming apparatus 1, the second opening and closing member 80 follows the first opening and closing member 70 and rotates in the opening direction A.

In other words, when a user pulls the first opening and closing member 70 from the closed state to the opened state with respect to the image forming apparatus 1, the first opening and closing member 70 rotates along the opening direction A. The portion of the second opening and closing member 80 on the other end side which is opposite from the one end side on which the hinged end 801 is provided follows the rotation of the first opening and closing member 70, comes into contact with the slope surface 703, and moves along the slope surface 703.

FIG. 4 is a cross-sectional view of the first opening and closing member 70 and the second opening and closing member 80 in the opened state with respect to the image forming apparatus 1. Since the first opening and closing member 70 has the slope surface 703, the second opening and closing member 80 does not hinder the movement of the first opening and closing member 70 from the closed state to the opened state with respect to the image forming apparatus 1. Therefore, the user is able to open the first opening and closing member 70 smoothly without problem.

Subsequently, the operating portion 702 as a grip provided on the first opening and closing member 70, which is necessary for opening the first opening and closing member 70 will be described. FIG. 5 is a perspective view showing the operating portion 702 provided on the first opening and closing member 70. FIG. 6 is a cross-sectional view showing the operating portion 702 provided on the first opening and closing member 70. The operating portion 702 is provided with a space in the interior thereof as the operating portion 702 which allows the user to insert his or her hand. The space in the interior of the operating portion 702 is provided with a holding portion 705 as a projection for allowing the user to hold the first opening and closing member 70 when opening the first opening and closing member 70.

The slope surface 703 provided on a part of the operating portion 702 has an opening continued from the space provided in the interior of the operating portion 702. Then, the end surface 704 of the operating portion 702 is provided with an area surrounded by a distance X extending from a boundary between the end surface 704 and the slope surface 703 in the height direction of the end surface 704 and a predetermined width Y extending along the boundary between the end surface 704 and the slope surface 703 as an opening. In other words, the opening provided on the end surface 704 of the operating portion 702 is provided continuously from the space provided in the interior of the operating portion 702. The user is able to insert his or her hand into the operating portion 702 from the opening provided on the slope surface 703 and the opening provided on the end surface 704 continued therefrom. The predetermined width Y may be changed as desired.

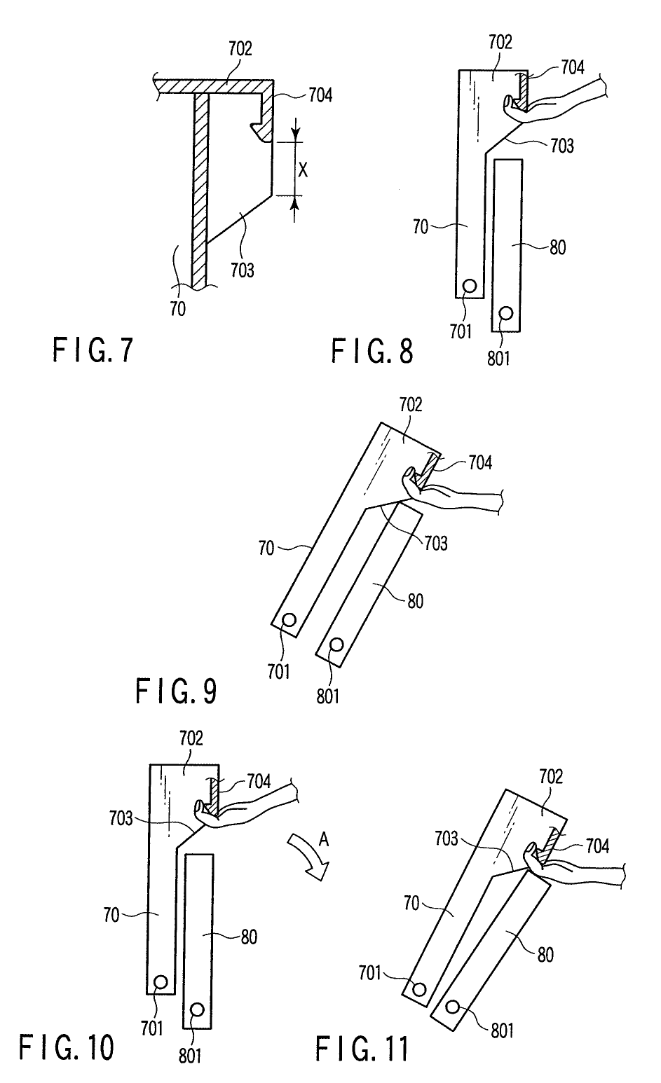

FIG. 7 is a cross-sectional view showing the operating portion 702 provided on the first opening and closing member 70 according to the embodiment. In the embodiment, the distance X which constitutes the opening provided on an end surface of the first opening and closing member 70 is larger than that in the related art. The distance X may be 20 mm or larger so as to prevent the hand from protruding downward from the boundary between the end surface 704 and the slope surface 703 even when an adult inserts his or her hand in the operating portion 702, for example.

FIG. 8 is a drawing showing a state in which the user puts his or her hand on the operating portion 702 provided on the first opening and closing member 70. FIG. 9 is a drawing showing a state in which the use is in the course of moving the first opening and closing member 70 from the closed state to the opened state. Even when the user puts his or her hand on the operating portion 702, his or her hand does not protrude outward from the slope surface 703. Therefore, probability that the user gets his or her hand wedged between the second opening and closing member 80 moving along the slope surface 703 of the first opening and closing member 70 and the operating portion 702. Even when the distance X is increased, the strength of the first opening and closing member 70 has no or little possibility to change. Therefore, the operating portion 702 having a structure with improved convenience without upsizing may be provided in the first opening and closing member 70. The second opening and closing member 80 may have a depressed shape at a position opposing the operating portion 702 provided on the first opening and closing member 70. Therefore, even when the user's hand inserted into the operating portion 702 protrudes outward from the slope surface 703, the user is not at a risk of getting his or her hand wedged between the second opening and closing member 80 and the operating portion 702 owing to the presence of the depression provided on the second opening and closing member 80. The operating portion 702 is arranged at a position where an end portion of the second opening and closing member 80 does not interfere when the first opening and closing member 70 and the second opening and closing member 80 are opened.

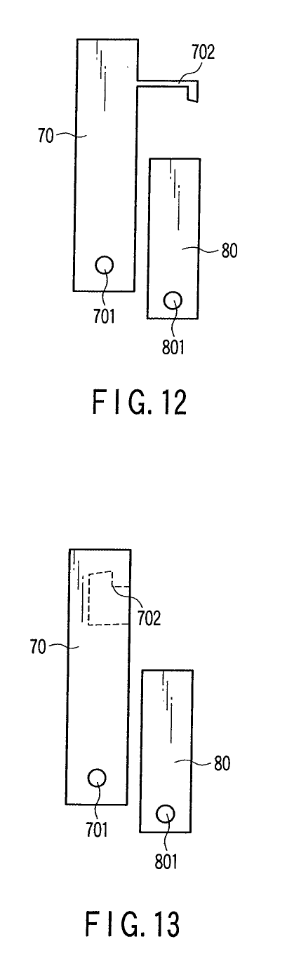

Subsequently, a second embodiment will be described. FIG. 12 is a cross-sectional view of the first opening and closing member 70 and the second opening and closing member 80. When the first opening and closing member 70 and the second opening and closing member 80 are in the closed state with respect to the image forming apparatus 1, the first opening and closing member 70 assumes a parallelepiped box shape. The first opening and closing member 70 is provided with the operating portion 702 of a grip shape projecting from the outer surface thereof in the horizontal direction. An upper surface of the second opening and closing member 80 has a shape covered with the operating portion 702 provided on the first opening and closing member 70.

When the user pulls the first opening and closing member 70 from the closed state to the opened state with respect to the image forming apparatus 1, the second opening and closing member 80 moves along the side surface of the first opening and closing member 70. The operating portion 702 is arranged at a position avoiding interference with the end portion of the second opening and closing member 80 and the user's hand when opening the first opening and closing member 70 and the second opening and closing member 80. Therefore, the second opening and closing member 80 does not hinder the movement of the first opening and closing member 70 from the closed state to the opened state with respect to the image forming apparatus 1.

Subsequently, a third embodiment will be described. FIG. 13 is a cross-sectional view of the first opening and closing member 70 and the second opening and closing member 80. When the first opening and closing member 70 and the second opening and closing member 80 are in the closed state with respect to the image forming apparatus 1, the second opening and closing member 80 assumes a parallelepiped box shape having an I-shape in cross-section. The operating portion 702 is formed in the interior of the first opening and closing member 70. The operating portion 702 is arranged at a position where the interference between the user's hand inserted into the operating portion 702 and the end portion of the second opening and closing member 80 when opening the first opening and closing member 70 and the second opening and closing member 80 is avoided. Therefore, the second opening and closing member 80 does not hinder the movement of the first opening and closing member 70 from the closed state to the opened state with respect to the image forming apparatus 1.

It is also possible to open only the second opening and closing member 80 with the first opening and closing member 70 kept closed. Although the first opening and closing member 70 described in the embodiments are connected to the image forming unit 10, it may be designed to be connected to the paper feeding unit 20.

What is claimed is:

1. An image forming apparatus comprising:
a first opening and closing member that rotates about a first hinged end;
a second opening and closing member provided so as to oppose the first opening and closing member, the second opening and closing member rotating about a second hinged end in association with opening of the first opening and closing member; and
an operating portion provided on the first opening and closing member, arranged at a position to avoid interference of an end portion of the second opening and closing member when opening the first opening and closing member and the second opening and closing member, and which rotate the first opening and closing member.

2. The apparatus of claim 1, wherein the operating portion includes a slope surface at a position coming into contact with the second opening and closing member.

3. The apparatus of claim 2, wherein the operating portion includes openings integrally with an end surface and the slope surface of the operating portion, and a space in the interior thereof.

4. The apparatus of claim 3, wherein the opening provided on the end surface of the operating portion has a size which prevents a hand from protruding downward from a boundary between the end surface and the slope surface.

5. The apparatus of claim 4, wherein the size of the opening provided on the end surface is 20 mm or larger in the height direction.

6. The apparatus of claim 1, wherein the operating portion protrudes from the first opening and closing member in the horizontal direction.

7. The apparatus of claim 1, wherein the operating portion is provided in the interior of the first opening and closing member.

8. The apparatus of claim 1, wherein the second opening and closing member rotates independently from the first opening and closing member.

9. A paper feeding device comprising:
a first opening and closing member that rotates about a first hinged end;
a second opening and closing member provided so as to oppose the first opening and closing member, the second opening and closing member rotating about a second hinged end in association with opening of the first opening and closing member; and
an operating portion provided on the first opening and closing member, arranged at a position to avoid interference of an end portion of the second opening and closing member when opening the first opening and closing member and the second opening and closing member, and which rotate the first opening and closing member.

10. The device of claim 9, wherein the operating portion includes a slope surface at a position coming into contact with the second opening and closing member.

11. The device of claim 10, wherein the operating portion includes openings integrally with an end surface and the slope surface of the operating portion, and a space in the interior thereof.

12. The device of claim 11, wherein the opening provided on the end surface of the operating portion has a size which prevents a hand from protruding downward from a boundary between the end surface and the slope surface.

13. The device of claim 12, wherein the size of the opening provided on the end surface is 20 mm or larger in the height direction.

14. The device of claim 9, wherein the operating portion protrudes from the first opening and closing member in the horizontal direction.

15. The device of claim 9, wherein the operating portion is provided in the interior of the first opening and closing member.

16. The device of claim 9, wherein the second opening and closing member rotates independently from the first opening and closing member.

17. An image forming apparatus comprising:
first means for being rotated about a first hinged end;
second means provided so as to oppose the first means, the second means rotating about a second hinged end in association with opening of the first means; and
operating means for operating the first means, the operating means being provided on the first means and being arranged at a position to avoid interference of an end portion of the second means when opening the first means and the second means.

18. The apparatus of claim 17, wherein the operating means includes a slope surface at a position coming into contact with the second means.

19. The image forming apparatus of claim 18, wherein the operating means includes openings integrally with an end surface and the slope surface of the operating means, and a space in the interior thereof.

20. The apparatus of claim 19, wherein the opening provided on the end surface of the operating means has a size which prevents a hand from protruding downward from a boundary between the end surface and the slope surface.
